(19) United States
(12) Patent Application Publication
(10) Pub. No.: US 2014/0375427 A1
(43) Pub. Date: Dec. 25, 2014

(54) SECURITY FILM COMPRISING A RADIO FREQUENCY READABLE CODE

(71) Applicants: Paul Peter Wilkinson, Faloppio (IT); Sergio Molino, Alfiano Natta (IT)

(72) Inventors: Paul Peter Wilkinson, Faloppio (IT); Sergio Molino, Alfiano Natta (IT)

(73) Assignee: NICANTI OY, Helsinki (FI)

(21) Appl. No.: 14/127,948

(22) PCT Filed: Jun. 19, 2012
(86) PCT No.: PCT/IB2012/053087

§ 371 Date: Aug. 6, 2014

(30) Foreign Application Priority Data
Jun. 20, 2011 (IT) TO2011A000537

(51) Int. Cl. G06K 19/067

(52) U.S. Cl. CPC G06K 19/067
USPC 340/10.1

(57) ABSTRACT

A security film (10,11) includes a film (1) onto which an electric code (50) is applied, which is obtained by way of at least one ink having particular electric properties, the electric code (50) including digital information that can be extracted by using radio frequency.

The present invention relates to a security film comprising a radio frequency readable code. More in particular, the present invention relates to a security film comprising a radio frequency readable code, adapted to be inserted into a polymeric or paper-based support. Printed electric codes are known in the art which are applied to an object so that it can be identified and/or tracked.

For example, international patent application no. WO 2009/138571 discloses a method for generating an electric code by exploiting some electric properties of inks.

According to the above-mentioned international patent application, the electric code is read by analyzing how a surface containing electric codes printed in accordance with said method reacts to radio frequency.

Electrodes are used to supply an alternating (or anyway non-constant) electric signal to the electric code and then, again by using said electrodes, the response current or voltage is measured.

Compared to other electric code reading systems not using radio frequency, the method described in the above-mentioned international patent application ensures a more reliable reading, thanks to the quality of the signal provided by analyzing the conductive properties of the ink and to the capability of obtaining said signal even when the code is read without contact, i.e. on the back side of the substrate whereto the electric code has been applied, or through a graphic decoration layer or a protection layer protecting the code against external agents.

The use of radio frequency also allows to better analyze the electric properties of the ink, and therefore to use inks having special properties, such as dielectric ones, for creating the electric code.

Still according to said international patent application, when the electric code is laminated inside one or more lamination layers, radio frequency allows reading said electric code even though there is a certain physical distance between the code itself and the electrodes.

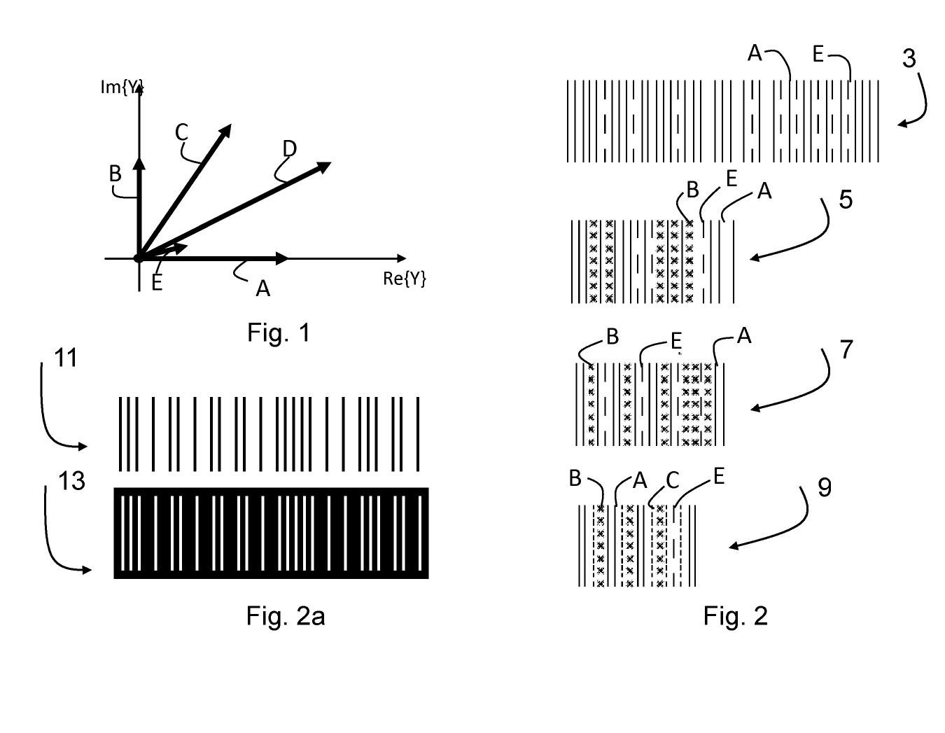

Another advantage obtained by using radio frequency is that it also allows to analyze in detail the electric properties of the ink, which, when read by a suitable radio frequency reader, generates a signal that can vary both in amplitude and in the ratio between the real part and the imaginary part, as shown in FIG. 1, which illustrates the real and imaginary electric behaviours of various types of ink A, B, C, D and E.

Electric codes are currently created by printing inks having predefined electric properties directly onto the final substrate. Although flexible, this process is often neither practical nor secure.

For example, when producing security paper for paper money, it is not advantageous for the security paper manufacturer to print an electric code directly onto the paper during the security paper production process.

In addition, in order to print an electric code, it is necessary that the operator knows the geometric arrangement of the electric code to be printed and the various inks to be used. These very inks might be used for cloning previously printed codes, since in order to clone an electric code it is sufficient to know the geometric sequence to be printed and the specific inks that must be used.

In this regard, cloning a code means to print or create a code without knowing the logic that generated it, whereas copying a code means to print or create a code when the generation logic thereof is known.

Since electric codes are mainly used in the security field, it is important to safeguard the management of the confidentiality thereof during the printing process.

It is further known in the art to insert into the paper a security film, also called security thread, which contains information obtained by printing known magnetic inks, said information being readable through known sensors.

The security film or security thread may also be of the fluorescent type (the thread emits fluorescence when exposed to ultraviolet rays) or of the holographic type (holographic patterns are provided in the film), or may be obtained by means of polychrome decorations. However, prior-art security films can only contain very small quantities of information, typically a few bit units per inch, and cannot be printed digitally, thus making it impossible or extremely unpractical to change the information contained in the code itself, which change may be either serial or random.

It is therefore an object of the present invention to provide a security film adapted to be inserted into a support, in particular into a polymeric or paper-based support.

It is a further object of the present invention to indicate a security film which can be applied to security paper or another material during the process for manufacturing the latter, and which is created beforehand through either analog printing techniques or digital printing techniques.

It is a further object of the present invention to indicate a security film comprising an electric code that contains a sufficient quantity of information, allowing said code to be used for ensuring traceability of the paper in which the security film has been inserted.

In short, the present invention describes a security film comprising a radio frequency readable code, which is applied onto a polymeric or paper-based substrate through a printing, transfer, mechanical ablation or chemical removal technique.

The security film may be laminated inside, or on the surface, of additional paper-based or polymeric materials in order to obtain a laminated material containing digital information defined by the manufacturer, and having a linear density that may even, but not exclusively, be substantially greater than 10 BPI (Bits Per Inch).

The digital information, correlated to the electric behaviour of parts of the code and to their geometric arrangement, is extracted from the laminated material by using a reader capable of generating and analyzing the behaviour of materials when they are placed in an electric field which is not constant in time.

Said objects are achieved through a security film comprising a radio frequency readable code and having the features set out in the appended claims, which are intended to be an integral part of the present description.

The invention will now be described in detail in some of its preferred embodiments, which are provided herein by way of non-limiting example, with reference to the annexed drawings, wherein:

FIG. 1 shows a graph representing the real and imaginary electric behaviours of various types of inks having specific electric properties;

FIGS. 2 and 2a show various types of electric codes;

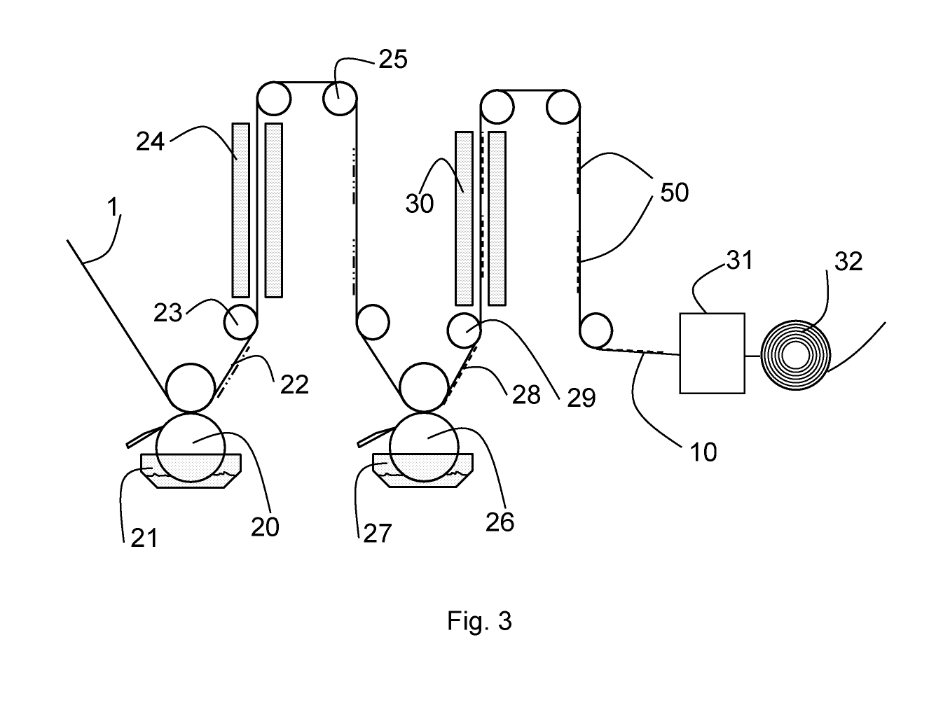

FIG. 3 shows a method for producing a security film according to the invention, onto which an electric code is printed;

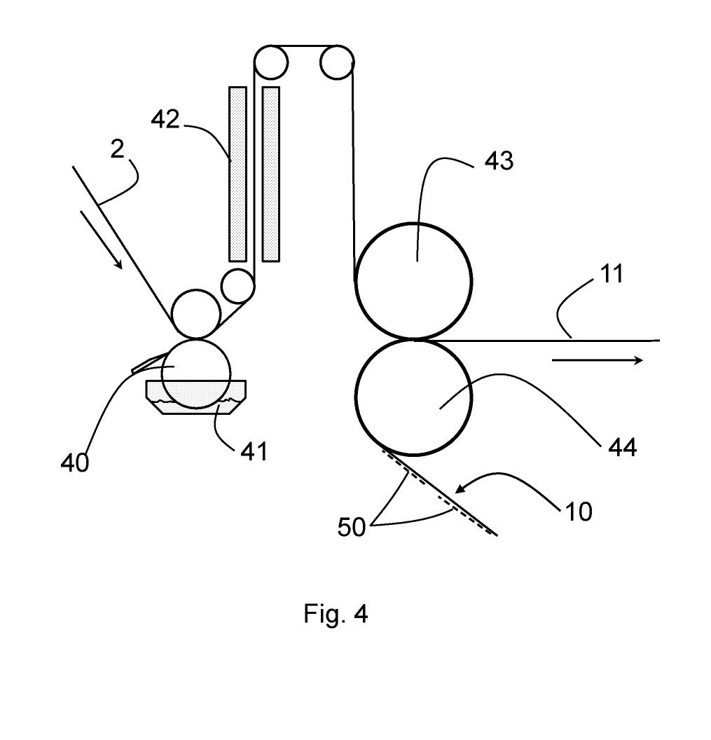

FIG. 4 shows a process for laminating the security film of FIG. 3;

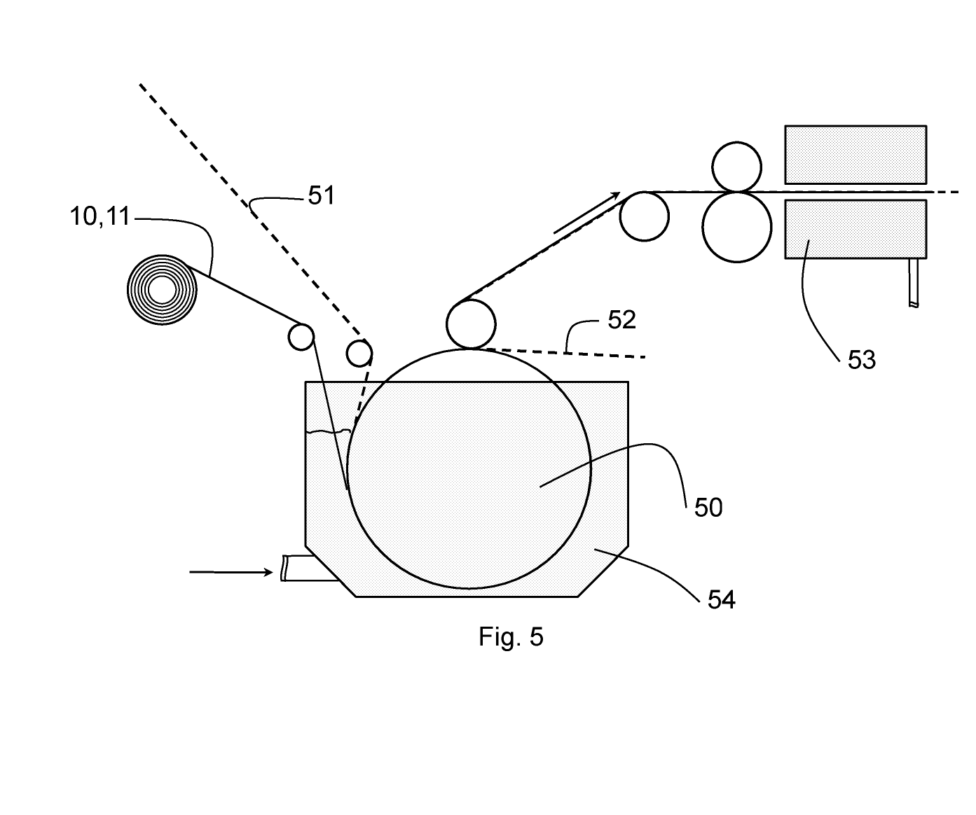

FIG. 5 shows a method for inserting the security film of FIG. 3 into paper pulp in order to obtain a laminated sheet;

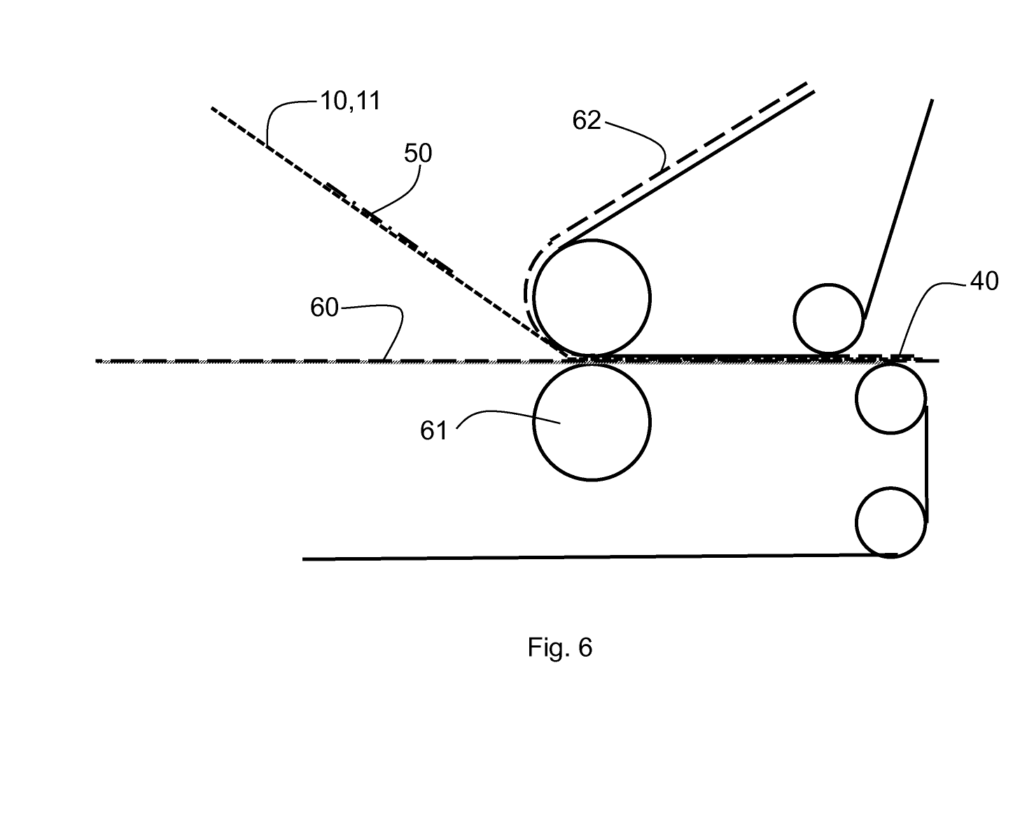

FIG. 6 shows a lamination method wherein a security film is laminated onto a paper-based support;

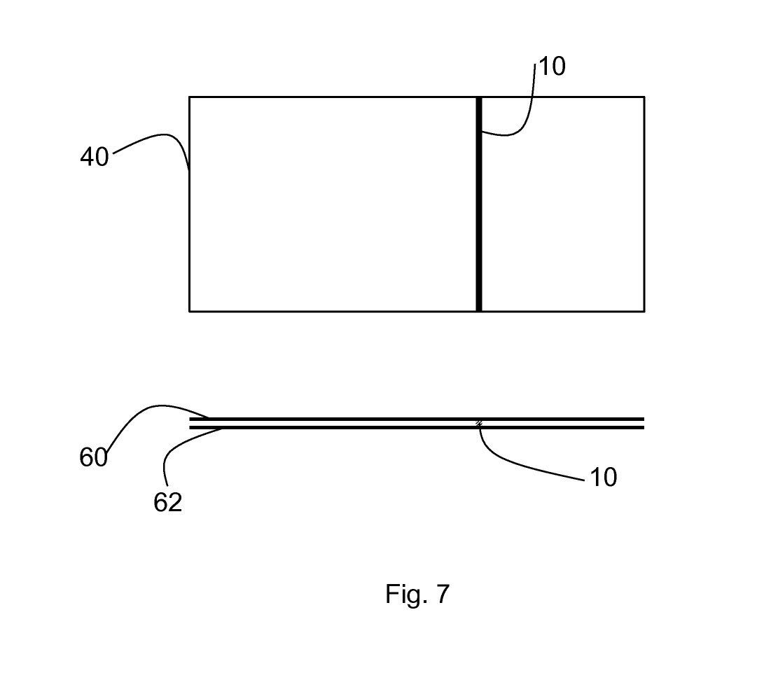

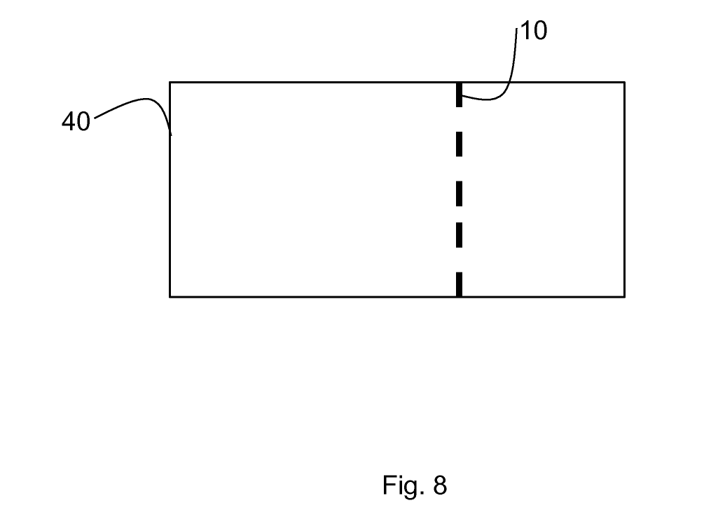

FIGS. 7 and 8 show paper money, in particular a banknote, comprising a security thread obtainable from the security film according to the present invention.

For the purposes of the present description, a security film is a film made of plastic material or another material, which comprises an electronic code applied to a support or integrated, even only partially, into the support itself during the process for manufacturing said support. With reference to FIG. 2, there are shown electric codes 3,5,7 and 9 using two or more inks A,B,C,E (or other materials allowing to obtain the same effect) with different electric properties.

The codes 3,5,7,9 contain the same quantity of information. As the number of inks used for creating the electric code increases, the number of bars of the code itself is reduced, thereby resulting in increased information density.

If the inks have the same colour, the code can only be distinguished by using a radio frequency reader.

With reference to FIG. 2a, there are also shown a “positive” electric code 11 and a “negative” electric code 13 created by using only one ink; on the one hand, this simplifies the making of the code, but on the other hand it makes the code 11,13 more vulnerable from a security viewpoint and less capable of allowing high information density.

The electric codes 11,13 contain the same digital information, although they are represented in two different ways.

FIG. 3 describes a process for printing an electric code of the type shown in FIG. 2 through an analog printing technique, in particular by using rotogravure cylinders. Other possible analog printing techniques for printing the electric code are offset printing and flexographic printing.

A film 1, e.g. a polyethylene terephthalate film having, for example, a thickness of 8 is appropriately fed to a first engraved cylinder 20 turning inside a first container 21, thus getting impregnated with a first electric ink, e.g. an A-type ink. The film 1 may also be a film made of paper-based material.

The engraving on the first cylinder 20 causes a first portion 22 of the electric code 50 to be formed on the film 1. Through a first roller 23, the film 1 is then fed to first drying means 24, e.g. a first oven, where it is dried in a manner such that the first portion 22 of the electric code 50 adheres perfectly to the film 1 itself.

Through a second roller 25, the film 1 is fed to a second engraved cylinder 26 turning inside a second container 27, thus getting impregnated with a second electric ink, e.g. a C-type ink. The engraving on the second cylinder 26 causes a second portion 28 of the electric code 50 to be formed on the film 1. Through a second roller 29, the film 1 is then fed to second drying means 30, e.g. a second oven, where it is dried in a manner such that the first portion 22 and the second portion 28 of the electric code 50 adhere perfectly to the film 1 itself. At the exit of the second drying means 30 there will be a security film 10 comprising the film 1 on which an electric code 50 has been printed.

Subsequently, the security film 10 can be cut at a cutting station 31, through cutters or other cutting techniques, to be sized in a manner such as to obtain the required final height, which is typically between 1 and 5 mm, but may be smaller or greater than this range of values, without limitation whatsoever, depending on specific requirements in terms of processing and of readability of the electric code 50. The security film 10 is then wound into suitable coils 32.

Daughter coils are thus obtained, or reels of electric wire in the case wherein the height thereof is in the range of a few millimetres, which contain electric codes 50 whose analog or digital nature depends on the printing process employed.

Of course, the electric code 50 may be made by using at least one additional ink, which will require a respective cylinder and a respective drying means.

The security film 10 may also be obtained through digital printing techniques, e.g. ink jet printing or thermal transfer ribbon printing.

In the case of ink jet printing, the film 1 is first coated, if required by the chemical nature of the support, with a “primer” to facilitate reception of an electric ink having calibrated electric properties.

While analog techniques, such as rotogravure printing, allow to produce low-cost films 10 offering very good performance of the electric code, the use of the digital techniques allows for unitary changes of the electric code 50, i.e. each code can be different from all others, according to a serial or random technique.

The security film 10 may also be obtained by mechanical ablation, i.e. by mechanically removing one or more layers of material with specific electric properties, which have been previously deposited onto the film 1. A laser beam is typically used for this process.

The security film 10 may also be obtained through “negative” mechanical ablation of a film, e.g. made of polyethylene terephthalate, previously smeared as a coating layer, e.g. 2 μm thick, having controlled electric properties.

The security film 10 may also be obtained by chemical removal, i.e. by removing a part of the layers of materials having predefined electric properties, through the use of solvents or chemical reagents. Generally this process is preceded by a physical protection step, wherein the layer parts that must not be removed are coated.

The electric code 50 may therefore be either a “positive” or a “negative” one, and may be composed of one or more materials having predefined electric properties.

The white spaces of the codes 11,13 have electric properties which are different from those of the black spaces, and may also have electric properties wholly identical to those of the film 1.

The use of the “negative” technique is particularly advantageous for creating codes by ablation or chemical removal, and requires a special calibration of the radio frequency reader for the latter to be able to read the code through lamination layers.

Once made, the security film 10 comprising the electric code 50 may be subjected to further processing steps which are not strictly required for making the code readable, but may increase the security of the electric code 50 and/or the protection thereof against external agents.

With reference to FIG. 4, there is shown a lamination process wherein the security film 10 is laminated with a coating film 2 in order to protect the electric code 50, which is laminated between the film 1 and the coating film 2, thereby generating a protected security film 11 in which the electric code 50 is particularly well protected against external agents (water, solvents, and the like). Reading the electric code 50 is possible because the code itself is read by using radio frequency. More in detail, the coating film 2 is fed to a cylinder 40 which, while turning, gets impregnated with an adhesive substance, in particular glue, placed in a container 41. The adhesive substance is dried in a drying means 42, in particular an oven, and from there it is fed to a press 43, to which also the security film 10 is fed through a drive roller 44.

Decorations may also be printed onto the security film 10 or the protected security film 11. The film 1 or the coating film 2 may also be holographic films, provided that the holographic decoration is made in a manner such as to not significantly interfere with radio frequency. One may also create holographic decorations on the security film 10,11 after the application of the electric code 50. This is possible because the code is read by using radio frequency.

In the case of a protected security film 11 wherein the film 1 or the coating film 2 have been previously metallized, it is very simple to carry out subsequent processing steps for chemically removing the metallization in a controlled manner by using known technologies. The security film 10,11 may advantageously be used for obtaining security paper, without prejudice to obtaining a similar process by using polymeric film instead of paper or paper pulp.

The processes for inserting the security film 10,11 into laminated paper 40 may be of various kinds, all substantially compatible with those known techniques that do not require the use of temperatures that might damage the security film 10,11 or of solvents that might corrode the electric code 50 or the film 1 or the coating film 2 that make up the security film 10,11.

The security film 10,11 may be made of water-resistant materials, in which case it may be inserted into the laminated sheet through lamination processes requiring the presence of water.

This applies particularly, but not exclusively, to a protected security film 11 created with inks and glues exclusively soluble in organic solvents and with a film 1 and a coating film 2 of a polymeric material such as polyethylene terephthalate.

Thanks to this water-resistant property of the security film 10,11, the latter can also be inserted into cellulose pulp in order to obtain paper with an inserted security thread in a continuous or broken configuration, i.e. with interruptions of the security film 10,11.

With reference to FIG. 5, there is shown a process for inserting the security film 10,11 into paper pulp for obtaining a laminated sheet of the continuous or broken type.

The security film 10,11 is fed to a drum 50 immersed in a container 54 containing paper pulp. The same drum 50 is also fed with a first net 51 and a second net 52, so that at the exit of the drum 50 the security film 10,11 lies between the first net 51 and the second net 52. A press 53 then presses the resulting structure evenly.

If the security film 10,11 is to be inserted between two paper layers, it will be necessary to apply a glue or another aggregating material, similarly to FIG. 4, in order to cause the layers to adhere to each other.

If one wants to laminate the security film 10,11 on the surface of or inside polymeric films, the same procedures described above will apply. Furthermore, when polymeric films are used, adhesion between the lamination layers can be obtained not only by using glue, but also by exploiting known thermal effects, provided that the temperatures used for welding the layers together are lower than the maximum temperature that can be withstood by the security film 10,11.

With reference to FIG. 6, there is shown a lamination technique consisting in laminating the security film 10,11 directly onto a paper-based or polymeric support.

A first paper layer 60 is fed to a cylinder 61, towards which also a security film 10,11 whereon an electric code 50 is printed, and a second paper layer 62 are conveyed. At the exit of the cylinder 61 there is a laminated paper sheet 40 comprising the security film 10,11, compressed between two paper layers 60,62.

During the lamination process, it is important that any adhesives in use are chosen among those not significantly interacting with the reader's radio frequency.

The electric code 50 applied onto the security film 10 may contain a very high information density, of the order of magnitude of at least several tens of bits per inch. The information density can be chosen by the manufacturer of the film 1, and is dependent on many factors, the most important one being the thickness of the materials within which the security film 10,11 is to be laminated. Maximum information density is inversely correlated to the thickness of the final laminated product.

In order to read the electric code 50 contained in a laminated sheet 40 made of paper or a polymeric material, the laminated sheet 40 must be read in the area where the electric code 50 is located by dragging a specific radio frequency reader, e.g. the one described in international patent application WO 2009/138571, which needs to be suitably calibrated.

The reader will detect the sequence of the inks applied to the security film 10,11 and then, by using specific algorithms, will return the digital information encrypted therein.

The advantages given by the use of radio frequency for reading the electric code 50 can be summarized in the following points:
detection and reading of electric codes inserted in the laminated sheet, even from distances greater than 80 μm: therefore, if the code is inserted at half thickness, the final laminated sheet may be thicker than 160 μm;
possibility of reading codes printed on security films laminated in the broken manner;
reading of electric codes with an information density greater than that of magnetic ones by many orders of magnitude;
possibility of code serialization;
simple code reading, without requiring a motorized system for accurately controlling the code dragging speed;
mechanical simplicity of the reader, which only contains electric components and no motorized mechanical system.

With reference to FIG. 7, there is shown a laminated paper sheet 40 comprising a security film 10 that takes the shape of a transversal strip called security thread. This embodiment is especially suitable for a sheet of paper money, in particular for a banknote.

With reference to FIG. 8, the security film 10, or security thread, is broken, i.e. the strip is not continuous, but has interruptions.

The security thread is therefore a security thread having a reduced width, such as to occupy only a small part of the surface, or projection, of the support. Typically, but not exclusively, security threads are less than 6 mm wide. Also the security thread can therefore be applied onto the support, completely incorporated into the support itself when manufacturing the latter or partially incorporated on the support to generate a broken thread.

The features of the present invention, as well as the advantages thereof, are apparent from the above description.

Advantageously, the security film comprising a radio frequency readable code according to the present invention allows to avoid involving the paper (or polymeric film) manufacturer in the processes for generating and applying electric codes to the film, since such processes can be carried out in the most secure conditions at a workshop specialized in the application of electric codes.

Advantageously, the process for inserting the code into the support is such that the code can be neither removed nor modified, while being protected from external agents and indifferent to subsequent printing or processing of the paper.

Advantageously, the electric code allows tracing the support by production period, paper batch, polymeric substrate batch or even serially, if each electric code identifies a specific support.

The security paper comprising the security film of the present invention is very hard to copy or clone, in that the counterfeiting process would require:
the possession of many specific and costly pieces of equipment;
the capability of stocking security materials such as inks with particular electric properties;
in-depth knowledge of the technology for generating electric security codes.

In addition, the fact that the electric code can be regularly changed advantageously allows tracing the paper batch used and/or isolating paper stolen by criminal organizations.

The security film comprising a radio frequency readable code described herein by way of example may be subject to many possible variations without departing from the novelty spirit of the inventive idea; it is also clear that in the practical implementation of the invention the illustrated details may have different shapes or be replaced with other technically equivalent elements.

It can therefore be easily understood that the present invention is not limited to a security film comprising a radio frequency readable code, but may be subject to many modifications, improvements or replacements of equivalent parts and elements without departing from the inventive idea, as clearly specified in the following claims.

1. A security film comprising a film onto which an electric code is applied, which is obtained by means of at least one ink having particular electric properties, said electric code comprising digital information that can be extracted by using radio frequency.

2. A security film according to claim 1, wherein said electric code is applied by using an analog printing technique.

3. A security film according to claim 2, wherein said analog printing technique comprises rotogravure printing, offset printing and flexographic printing.

4. A security film according to claim 1, wherein said electric code is applied by using a digital printing technique.

5. A security film according to claim 2, wherein said digital printing technique comprises ink jet printing and thermal transfer ribbon printing.

6. A security film according to claim 1, wherein said electric code is applied by using a mechanical ablation technique.

7. A security film according to claim 1, wherein said electric code is applied by using a chemical removal technique.

8. A security film according to claim 1, wherein said security thread comprises a coating film arranged in a manner such that said electric code is protected by said coating film.

9. A security film according to claim 8, wherein said coating film is made of a polymeric or paper-based material.

10. A security film according to claim 1, wherein said film is made of a paper-based or polymeric material.

11. A security film according to claim 1, wherein said film comprises prints, decorations or holograms.

12. A laminated sheet comprising a first layer of paper-based or polymeric material and a second layer of paper-based or polymeric material, wherein a security film according to claim 1 is provided between said first layer and said second layer.

13. A paper money item, in particular a banknote, comprising a laminated sheet according to claim 12, wherein said security film, in particular a security thread, is arranged transversally to said paper money item.

14. A paper money item according to claim 13, wherein said security film is of the broken type.

15. A method for making a security film, comprising the step of applying at least one ink having particular electric properties onto a film, so as to form an electric code which comprises digital information that can be extracted by using radio frequency.
